(19) United States
(12) Patent Application Publication
(10) Pub. No.: US 2005/0046371 A1
(43) Pub. Date: Mar. 3, 2005

(54) Method and apparatus for controlling a brushless DC motor

(75) Inventors: Martin Degen, Schmitten (DE); Reiner Grossmann, Kelkheim-Fischbach (DE); Bernd Hexamer, Meddersheim (DE); Heiko Jausel, Neustadt an der Weinstrasse (DE); Werner Weiss, Usingen (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 10/849,416

(22) Filed: May 19, 2004

(30) Foreign Application Priority Data
Aug. 25, 2003 (DE) 103 39 028.6

(51) Int. Cl. H02P 7/50

(52) U.S. Cl. 318/439

(57) ABSTRACT

Below a predetermined threshold value of the rotation speed, a sinusoidal or trapezoidal current is applied to the winding sections of a brushless DC motor. Above the predetermined threshold value of the rotation speed, the brushless DC motor is operated with block commutation. The brushless DC motor thus produces a very uniform torque over a very wide operating range, and can at the same time be designed to be very compact.

### BACKGROUND OF THE INVENTION

1. Field of the Invention

The invention relates to a method and an apparatus for controlling a brushless DC motor.

2. Description of the Related Art

Brushless DC motors (BLDC motors) are electric machines with permanent magnets in the rotor. The rotor produces an excitation field. The stator of the BLDC motor has a three-phase winding and is fed from an inverter, which provides three-phase power to the stator. BLDC motors are self-commutated machines, and require a rotation angle position sensor for operation. Together with the field of the permanent magnet, an armature current forms a torque which is as constant as possible over time. The stator field is switched further with the aid of the inverter as a function of the rotor position such that a constant angle of π/2, electrical, is produced between the stator rotation flux and the rotor field. The rotor position is preferably recorded by sensors, or is derived from terminal voltages and/or terminal currents. The operating behavior corresponds largely to that of the DC motor. BLDC motors have very good dynamics and can easily be controlled. The brushless technology is wear-free and maintenance-free.

BLDC motors are used in particular for servo steering systems in motor vehicles. Servo steering systems are devices for amplifying a steering force that is applied by the driver of the motor vehicle. The force is amplified electromechanically by the BLDC motor. The servo steering system preferably has a torque sensor, which records the instantaneous torque transmitted from the driver to the steering wheel. The torque is then amplified, in which case the gain factor may be dependent on various operating parameters of the motor vehicle. The BLDC motor is then appropriately driven. The BLDC motor is preferably coupled by a transmission to the steering device for the motor vehicle. Irregularities in the torque which is emitted from the BLDC motor are perceived by the driver as jerkiness on the steering wheel. Torque uniformity is thus a significant factor for optimal driving convenience. Torque irregularities as described above are also referred to as torque ripple.

A method and an apparatus for controlling a BLDC motor which is operated with block voltage commutation are known from German Patent reference DE 199 38 678 A1. The DC motor is driven such that the applied voltage differs from the voltages provided for block commutation as a function of the rotation speed of the motor and of the current drawn by it. A table is provided for this purpose, from which amended pulse widths are read for switching of the windings of the DC motor as a function of the rotation speed N and current values, and these are driven accordingly.

### SUMMARY OF THE INVENTION

The object of the invention is to provide a method and an apparatus for controlling a BLDC motor such that the BLDC motor can be operated over a wide rotation speed range with minimal torque irregularities or torque ripple.

The present invention is distinguished by a method and a corresponding apparatus for controlling the BLDC motor, in which a sinusoidal or trapezoidal current is applied to the winding sections of the BLDC motor when the rotational speed of the BLDC motor is below a predetermined threshold value. This has the advantage that, below the predetermined threshold value, torque ripple is highly effectively reduced by applying the sinusoidal or trapezoidal current waveform instead of block commutation.

The invention is also distinguished in that, above the predetermined threshold value of the rotation speed, the motor is operated by block commutation. This has the advantage that only a small amount of physical space is required even for operation of the BLDC motor over a wide rotation speed range and a wide power range, since the BLDC motor is operable with very high efficiency by block commutation. The efficiency is up to 25% higher than in the case of operation when a sinusoidal or trapezoidal current is applied.

In one embodiment of the present invention, the threshold value of the rotation speed is approximately half the no-load rotation speed of the BLDC motor. This has the advantage that, above this rotation speed, the torque ripples which occur are increasingly smoothed by the mass inertia of the rotor of the BLDC motor.

In a further embodiment of the present invention, above a first threshold value of the rotation speed up to a second threshold value of the rotation speed, a sliding transition takes place from the sinusoidal or trapezoidal application of the current to block commutation. The threshold value is between the first and the second threshold value. This has the advantage that the efficiency can be increased even from the first threshold value of the rotation speed and that, at rotation speeds above the second threshold value, virtually no torque irregularities occur during block commutation, owing to the mass inertia of the rotor. In this case, the first threshold value of the rotation speed may correspond to approximately 1/3 of the no-load rotation speed of the BLDC motor, and the second threshold value of the rotation speed may correspond to approximately 2/3 of the no-load rotation speed of the BLDC motor.

In a further refinement of the invention, a voltage profile which is applied to the winding sections of the BLDC motor is determined using a model of the DC motor as a function of the sinusoidal or trapezoidal current profile to be applied, and this voltage profile is controlled. This has the advantage that the current may be adjusted accurately, even without a current sensor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic block diagram showing a BLDC motor and an apparatus for controlling the BLDC motor; and

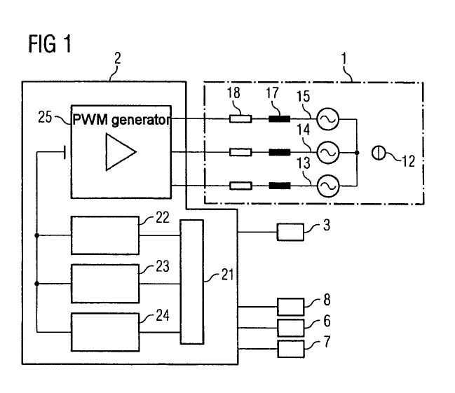

FIG. 2 is a flowchart of a program for controlling the BLDC motor shown in FIG. 1.

### DETAILED DESCRIPTION OF THE PRESENTLY PREFERRED EMBODIMENTS

The BLDC motor 1 has a rotor 12 with permanent magnet excitation and a stator which preferably has three winding sections 13, 14, 15. The load which is applied to each of these winding sections 13-15 may be represented by an inductance 17 and a resistance 18. The three winding sections 13-15 are preferably connected in star.

An apparatus 2 for controlling the BLDC motor 1 includes a decision unit 21, first, second, and third control units 22, 23, 24, and a pulse-width modulation generator 25.

Operating parameters such as the rotation speed N at which the BLDC motor 1 is intended to by operated or the torque TQ which the BLDC motor 1 is intended to generate, are transmitted to the decision unit 21. These operating parameters are used by the decision unit 21 to decide the control mode CTRL in which the BLDC motor should be operated. For this purpose, the control unit 2 may, for example, have an associated torque sensor 7 on a column that is coupled to the steering wheel to record the torque produced by a driver of the motor vehicle in which the BLDC motor is installed. The torque TQ to be applied by the BLDC motor is then determined as a function of this torque and, possibly, of other operating parameters relating to the motor vehicle.

The apparatus 2 for controlling the BLDC motor 1 also includes an associated position sensor 3 to record the angular position of the rotor 12. The actual rotation speed N may be determined as a function of the time profile of the recorded angular position. The position sensor 3 may be a Hall sensor, a magnetoresistive sensor, an optical sensor or a so-called resolver.

The decision unit 21 decides which of the control units 22 to 24 will produce an actuating signal for a pulse-width modulation generator 25. This decision is made as a function of the control mode CTRL to be controlled. The control mode CTRL may be SINTRAP for applying a sinusoidal or trapezoidal current, TRANS for a transitional mode, or BLOCK for block commutation. If the control mode CTRL is SINTRAP, then the first control unit 22 produces the actuating signal. If, in contrast, the control mode CTRL is TRANS, then the second control unit 23 produces the actuating signal. If the control mode CTRL is BLOCK, then the third control unit 24 produces the actuating signal.

The pulse-width modulation generator 25 produces voltage signals which are applied by a bridge circuit (which is associated with the pulse-width modulation generator 25) to the respective winding sections 13, 14, 15 of the BLDC motor 1.

It is advantageous to provide at least two current sensors 6, 8, which each record the current in one of the winding sections 13 to 15.

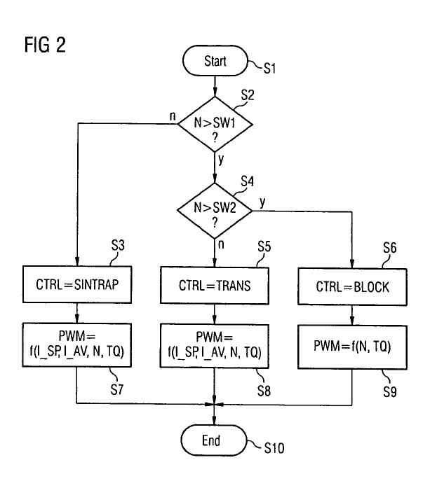

A program for controlling the BLDC motor 1 is stored in the apparatus 2 for controlling the BLDC motor 1, and is processed during operation of the BLDC motor 1. The program is illustrated in FIG. 2 and is started in a step S1, in which variables may be initialized.

A check is carried out in a step S2 to determine whether the rotation speed N at which the BLDC motor 1 is intended to be operated is greater than a first threshold value SW1. The first threshold value SW1 is preferably chosen to correspond to approximately 1/3 of the no-load rotation speed of the BLDC motor 1. If the condition in step S2 is not satisfied, then, in a step S3, the operating mode CTRL is controlled to apply the sinusoidal or trapezoidal current SINTRAP.

An actuating signal PWM for the pulse-width modulation generator 25 is then produced in a step S7. This is done as a function of the nominal value I_SP of the current in the respective winding section 13 to 15. The nominal value I_SP of the current is determined as a function of the torque which the BLDC motor 1 is intended to emit, and possibly additionally as a function of the rotation speed N at which the BLDC motor 1 is intended to be operated. A model of the BLDC motor is preferably provided, by means of which the actuating signal PWM is determined as a function of the nominal value I_SP of the current, or its sinusoidal or trapezoidal profile.

The application of the sinusoidal or trapezoidal current to the winding sections 13 to 15 at relatively low rotation speeds N, that is to say at rotation speeds N which are below the first threshold value SW1, results in the BLDC motor 1 producing a particularly uniform torque.

Alternatively or additionally, the current may also be regulated, by providing corresponding current sensors 6, 8. In this case, the actuating signal PWM for the pulse-width modulation generator 25 is determined as a function of the difference between the nominal value I_SP and an actual value I_AV of the current in the respective winding sections 13-15. This allows the current profile in the winding sections 13-15 to be set even more precisely, when the current sensors accurately record the actual value I_AV of the current.

If, on the other hand, the condition in step S2 is satisfied, and the rotation speed N at which the BLDC motor 1 is intended to be operated is greater than the first threshold value SW1, then a check is carried out in a step S4 to determine whether the rotation speed N at which the BLDC motor 1 is intended to be operated is greater than a second threshold value SW2.

If the condition in step S4 is satisfied, then, in a step S6, operation with block voltage commutation BLOCK is specified as the control mode CTRL.

The actuating signal PWM for the pulse-width modulation generator 25 is produced in a step S9 as a function of the rotation speed N and/or of the torque TQ which is intended to be emitted from the BLDC motor 1. Block commutation BLOCK is controlled. In the course of the block commutation BLOCK, voltage blocks of 120 degrees with 60 degree gaps or voltage blocks of 180 degrees, can be applied to the respective winding sections 13-15, depending on the rotation speed N at which the BLDC motor 1 is intended to be operated, or on the torque TQ at which the BLDC motor 1 is intended to be operated.

The magnitude of the voltage that is applied to the individual winding sections 13-15 in the control mode CTRL for block commutation BLOCK may also be adjusted by the pulse-width modulation as a function of the rotation speed N and/or of the torque TQ which the BLDC motor 1 is intended to produce.

In the control mode CTRL with block commutation BLOCK, the BLDC motor 1 is operated at high efficiency, this efficiency being up to about 25% higher than that in the control mode CTRL in which a sinusoidal or trapezoidal current SINTRAP is applied. Even a compact BLDC motor 1 can thus be operated, even at high rotation speeds N and high torques TQ. Since the control mode CTRL for block commutation BLOCK is assumed only when the rotation speed N is greater than the second threshold value SW2, which is preferably ⅔ of the no-load rotation speed N of the BLDC motor 1, this ensures that the torque irregularity during the control mode CTRL for block commutation BLOCK is very low. This is the case because the torque irregularities which generally occur with block commutation BLOCK are very greatly reduced by the mass inertia of the rotor 12 at high rotation speeds N which are more than ⅔ of the no-load rotation speed.

The program is then ended in a step S10. The program as shown in FIG. 2 is preferably processed once again after a time period which can be predetermined.

If the condition in step S4 is not satisfied, then a control mode CTRL for transition operation TRANS is selected.

The actuating signal PWM for the pulse-width modulation generator 25 is set in a step S8 as a function of the rotation speed N at which the BLDC motor 1 is intended to be operated, and the torque TQ which the BLDC motor 1 is intended to produce, and as a function of the nominal value I_SP and possibly the actual value I_AV of the current in the respective winding section 13 to 15. As the rotation speed rises, a sliding transition in this case takes place from the application of the sinusoidal or trapezoidal current SINTRAP to block commutation BLOCK. The drive in the transitional range is in this case dependent on stored information, which has been determined in advance by trials with the BLDC motor 1.

In one particularly simple embodiment of the present invention, either the control mode CTRL for regulation SIN based on a sinusoidal current or block commutation BLOCK is assumed. The decision on which control mode CTRL will be assumed is then made as a function of only one threshold value of the rotation speed N, which is then preferably approximately half the no-load rotation speed.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for controlling a brushless DC motor, comprising the steps of:
applying a sinusoidal or trapezoidal current to winding sections of the brushless DC motor when the rotational speed at which the motor is intended to be operated is below a predetermined threshold value, and
applying a block commutation voltage to the winding sections of the brushless DC motor when the intended rotational speed of the motor is above the predetermined threshold value.

2. The method of claim 1, wherein the threshold value of the rotation speed is approximately half the no-load rotation speed of the brushless DC motor.

3. The method of claim 1, wherein said step of applying a sinusoidal or trapezoidal current is performed when the intended rotational speed is not greater than a first threshold value, said step of applying a block commutation voltage is performed when the intended rotational speed is greater than a second threshold value, and said method further comprises the step of applying a sliding transition from the sinusoidal or trapezoidal application of current to the block commutation voltage when the intended rotational speed is above the first threshold value and not greater than the second threshold value, with the threshold value being between the first and the second threshold value.

4. The method of claim 3, wherein the first threshold value corresponds to approximately one third of the no-load rotation speed of the brushless DC motor, and the second threshold value of the rotation speed corresponds to approximately two thirds of the no-load rotation speed of the brushless DC motor.

5. The method of claim 3, further comprising the steps of determining a voltage profile to be applied to the winding sections of the brushless DC motor using a model of the brushless DC motor as a function of the sinusoidal or trapezoidal current profile to be applied, and controlling the determined voltage profile.

6. The method of claim 3, further comprising the steps of regulating the sinusoidal or trapezoidal current.

7. The method of claim 1, further comprising the steps of determining a voltage profile to be applied to the winding sections of the brushless DC motor using a model of the brushless DC motor as a function of the sinusoidal or trapezoidal current profile to be applied, and controlling the determined voltage profile.

8. The method of claim 1, further comprising the steps of regulating the sinusoidal or trapezoidal current.

9. An apparatus for controlling a brushless DC motor, comprising:
a first control unit for applying a sinusoidal or trapezoidal current to winding sections of the brushless DC motor when the rotational speed at which the motor is intended to be operated is below a predetermined threshold value, and
a second control unit for applying a block commutation voltage to the winding sections of the brushless DC motor when the intended rotational speed of the motor is above the predetermined threshold value.

10. The apparatus of claim 9, wherein said first control unit applies the sinusoidal or trapezoidal current when the intended rotational speed is not greater than a first threshold value, said second control unit applies a block commutation voltage when the intended rotational speed is greater than a second threshold value, and said apparatus further comprises an intermediate control unit for applying a sliding transition from the sinusoidal or trapezoidal application of current to the block commutation voltage when the intended rotational speed is above the first threshold value and not greater than the second threshold value, the predetermined threshold value being between the first and second threshold values.

11. The apparatus of claim 9, further comprising a decision unit for determining when to use the first control unit and the second control unit.
